(19) United States
(12) Patent Application Publication
(10) Pub. No.: US 2004/0019625 A1
(43) Pub. Date: Jan. 29, 2004

(54) Method and system for printing an image on a client device

(75) Inventors: Masaya Higuchi, Yamato-shi (JP); Isao Kadowaki, Zama-shi (JP)

Correspondence Address: A. Bruce Clay, IBM Corporation, T81/503, PO Box 12195, Research Triangle Park, NC, 27709, US

(73) Assignee: International Business Machines Corporation, Armonk, NY

(21) Appl. No.: 10/615,351

(22) Filed: Jul. 8, 2003

(30) Foreign Application Priority Data
Jul. 24, 2002 (JP) 2002-215686

(51) Int. Cl. G06F 15/16

(52) U.S. Cl. 709/201

(57) ABSTRACT

Java applets and data are downloaded into a client from a WEB data server to display a chart, datasheet, and the like in the WEB browser. Printing of the chart, datasheet, and the like is performed by transmitting displayed printing information to the WEB application server, preparing a file for printing based on the printing information received in the WEB application server, and transmitting the prepared file for printing to the client.

### TECHNICAL FIELD OF THE INVENTION

The present invention relates to a client server system for printing an image displayed in a WEB browser of a client, particularly to a server system, and the like suitable for using programs such as a Java applet operating on the WEB browser of the client to print the image displayed in the WEB browser.

### BACKGROUND OF THE INVENTION

In a client server system including a server connected to a client via a communication network, a system has heretofore been known in which the client acquires predetermined data from a database stored in the server and the client analyzes the data based on the acquired data. Moreover, in recent years, for a purpose of simplifying user's operability, a system has increasingly become a mainstream in which data is analyzed with the WEB browser disposed in the client.

In some of client server systems of this type, Java applet is embedded in data transmitted to the client from the server, the Java applet received on the client's WEB browser is executed, analysis is performed based on the acquired data, and, for example, a data sheet, chart, or the like is prepared.

Such client server system has an advantage that by the use of the Java applet it is unnecessary to introduce an exclusive-use module into individual clients. Moreover, since a file size of the Java applet for preparing the chart or data sheet is small, and a transmission time to the client from the server is only short, a flow of business is not disturbed.

Additionally, in the above-described client server system, there is a demand that images of a chart, data sheet, and the like prepared during the analysis by the client are to be printed.

However, when the image displayed in the WEB browser is printed by a printing command included in the client's WEB browser, a part of the chart or datasheet prepared using the Java applet lacks, or a blank state results. A technical problem has been seen that a desired printing result cannot be obtained.

As a simplest method of solving this technical problem, it can be contrived that a screen capture is used by the client to prepare a hardcopy of a display screen, and the hardcopy is then printed. However, when the chart or datasheet cannot be displayed in a display screen, it is necessary to scroll the display screen while performing the screen capture and printing in a plurality of divided installments. Therefore, this is very troublesome, and it is feared that the chart or datasheet could not be contained in one sheet.

Moreover, it is considered that the client introduces the exclusive-use printing module and uses this printing module to print the image. However, when this method is employed, it is necessary to introduce the printing modules into all the clients. Therefore, a maximum merit of the use of the Java applet, that is, an advantage that it is unnecessary to introduce the exclusive-use modules into the individual clients is impaired.

Furthermore, it can be contrived that a program which operates on a server such as Java Servlet is used to analyze the data and to prepare the image without using the Java applet, the image prepared by the server is transmitted to the client to display the image, and this image is then printed. However, when the data is analyzed on a server side, server-client communication has to be performed. Therefore, the analysis requires much time as compared with the analysis performed by the client, and business is disturbed.

Additionally, it is defined in a usual Java applet that a printer connected to the client for executing the Java applet cannot be accessed. However, by the use of a signed Java applet, the printer can also be accessed. Therefore, it is considered that this applet is used to print the image. However, in this method, it is possible to print individual charts and datasheets prepared by the respective Java applets, but it is difficult to print the whole image in which the charts or datasheets exist in a mixed manner.

### MEANS FOR SOLVING THE PROBLEMS

The present invention has been developed to solve the above-described technical problem, and an object thereof is to use a program operating on the WEB browser to print the image displayed in the WEB browser as desired.

As a result of intensive studies to solve the above-described technical problem, the present inventor has obtained findings that a printing result of an image prepared using Java applets differs with a type of an operating system (OS) of a client and type of a WEB browser mounted on the client. Moreover, it has been noted that the image prepared using the Java applets is converted to a data format not depending on the Java applets, and it is thereby possible to print the image displayed in the WEB browser, and the present invention has been developed.

That is, a client server apparatus of the present invention is characterized by comprising a client comprising a WEB browser for browsing a WEB page, and a server connected to the client via network, the above client comprising client transmission means for using a program operating on the WEB browser to transmit printing information corresponding to an image displayed in the WEB browser to the server, the above server comprising printing data preparation means for preparing the data for printing based on the received printing information, and server transmission means for transmitting the data for printing prepared by the preparation means of the data for printing to the client.

In the client server system according to the present invention, even when a plurality of clients different in an operating system (OS) or WEB browser software for use are connected to the server via the network, an image displayed in each client's WEB browser can be printed.

Moreover, in the client server system of the present invention, the printing information is characterized by including information on the image displayed in the WEB browser and/or information on a source of a text displayed in the WEB browser, or including additional information displayed or non-displayed in the WEB browser.

Furthermore, the client of the present invention is characterized by comprising judgment means for using the program operating on the WEB browser to judge whether there is a printing instruction with respect to an image displayed in the WEB browser, printing information preparation means for preparing the printing information based on the printing instruction, when the judgment means judges that there is the printing instruction, client transmission means for transmitting the printing information prepared by the printing information preparation means to a server via network, client reception means for receiving data for printing prepared by the server based on the printing information transmitted by the client transmission means from the server via the network, and output means for outputting the data for printing received by the client reception means.

Here, as the program operating on the WEB browser, Java applet downloaded via the network can be used.

It is to be noted that an output of a file for printing includes either a mode for displaying the data for printing in a screen of the client or a mode for allowing a printer to print the data for printing.

Furthermore, the server the present invention is characterized by comprising server reception means for receiving printing information on an image prepared by a program operating on a WEB browser of a client, preparing data preparation means for printing for the data for printing based on the printing information received by the server reception means, and server transmission means for transmitting the data for printing prepared by the preparation means of the data for printing to the client.

Here, when the data for printing prepared by the preparation means of the data for printing is a portable document format (PDF) file, it is preferably possible to achieve a layout in accordance with a sheet to be printed.

Moreover, the server of the present invention preferably further comprises form data storage means for storing form data of the data for printing prepared by the preparation means of the data for printing, and image data preparation means for preparing image data of the data for printing prepared by the preparation means of the data for printing.

Furthermore, a computer apparatus the present invention is characterized by comprising program module transmission means for transmitting a program module for preparing printing information based on an image displayed in a WEB browser of a client to the client, and printing data preparation means for preparing the data for printing based on the printing information prepared using the program module and transmitted from the client.

### BRIEF DESCRIPTION OF THE DRAWINGS

Embodiments of the present invention will now be explained in more detail, by way of example, with reference to the accompanying drawings in which:

FIG. 1 is a diagram showing a client server system according to one embodiment;

FIG. 2 is a diagram schematically showing an example of a hardware constitution of a computer apparatus suitable for realizing the client server system according to one embodiment;

FIG. 3 is a flowchart showing a client's operation;

FIG. 4 is a flowchart showing an operation of a WEB application server;

FIG. 5 is a diagram showing a display screen in a case in which a client opens a WEB browser;

FIG. 6 is a diagram showing a display screen in which a bar chart is displayed in the WEB browser;

FIG. 7 is a diagram showing a display screen in a case in which a line chart is displayed in the WEB browser;

FIG. 8 is a diagram showing a display screen in a case in which a pie chart is displayed in the WEB browser;

FIG. 9 is a diagram showing a display screen in a case in which a print button is clicked under a condition of display of the bar chart in the WEB browser;

FIG. 10 is a diagram showing a display screen in a case in which a PDF file (upper part:chart side) is displayed on the WEB browser; and

FIG. 11 is a diagram showing a display screen in a case in which a PDF file (lower part:datasheet side) is displayed on the WEB browser.

### DETAILED DESCRIPTION OF THE INVENTION

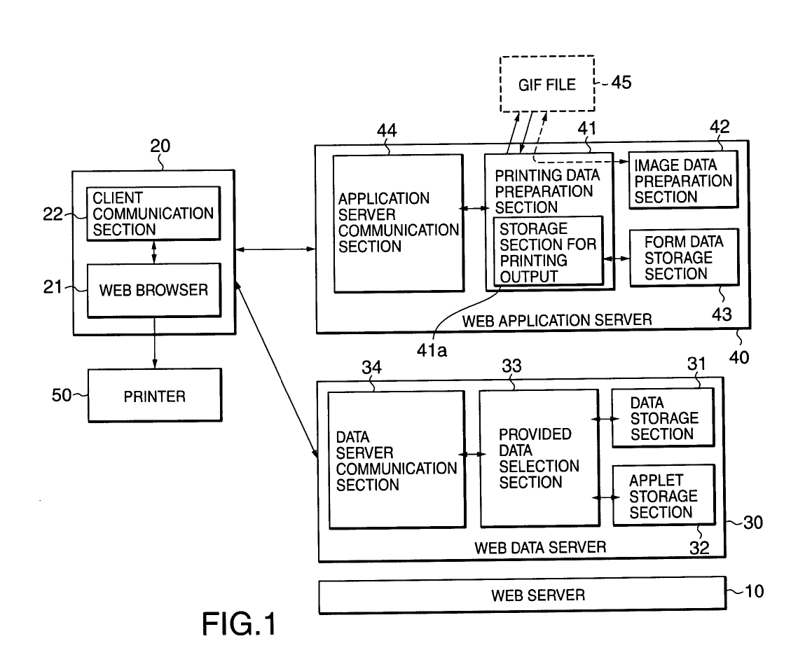

FIG. 1 is a block diagram showing functions of a client server system according to one embodiment to which the present invention is applied. This client server system includes a WEB server 10 and a client 20 connected to the server via a communication network (network). Of these, the WEB server 10 includes a WEB data server 30 in which data is stored, and WEB application server 40 in which applications are stored, and the client 20 is connected to a printer 50.

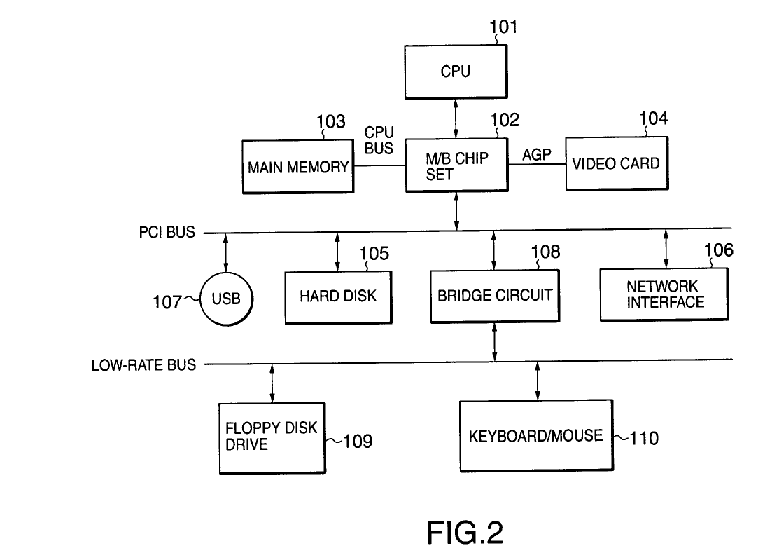

FIG. 2 schematically shows a hardware constitution of a computer apparatus suitable for realizing the WEB server 10 (WEB data server 30, WEB application server 40) and client 20 in the present embodiment.

The computer apparatus shown in FIG. 2 comprises: a central processing unit (CPU) 101 which is calculation means; a motherboard (M/B) chip set 102; a main memory 103 connected to the CPU 101 via a CPU bus; a video card 104 similarly connected to the CPU 101 via the M/B chip set 102 and accelerated graphics port (AGP); a hard disk 105 connected to the M/B chip set 102 via a peripheral component interconnect (PCI) bus; a network interface 106; a USB port 107; a floppy disk drive 109 connected to the M/B chip set 102 from the PCI bus via a bridge circuit 108 and low-rate bus such as an industry standard architecture (ISA) bus; and a keyboard/mouse 110. Moreover, for example, the printer 50 is connected to the client 20 via the USB port 107. Additionally, the printer 50 can be not only a local printer of the client 20 but also a network printer.

It is to be noted that FIG. 2 only illustrates a hardware constitution of the computer apparatus which realizes the present embodiment, and other various constitutions can be taken, when the present embodiment can be applied. For example, instead of disposing the video card 104, only a video memory is mounted, the CPU 101 may also be constituted to process image data, and drives of a compact disc read only memory (CD-ROM) or digital versatile disc read only memory (DVD-ROM) may also be disposed via interfaces such as an AT attachment (ATA).

Moreover, in FIG. 1, the client 20 includes a WEB browser 21 for browsing a WEB page, and client communication section 22 (including client transmission means, client reception means (both not shown)) for performing communication with the WEB server 10. Here, the WEB browser 21 is a software block realized by the program-controlled CPU 101 shown in FIG. 2. The program for controlling the CPU 101 to realize these functions is stored and distributed in storage mediums such as a magnetic disk, optical disc, and semiconductor memory, or distributed and provided via the network, and read in the main memory 103. Moreover, the client communication section 22 is realized by the network interface 106. It is to be noted that the data or program held in the main memory 103 can be taken into storage devices such as the hard disk 105 as the occasion demands.

Moreover, the WEB browser 21 operates on an operating system (OS), but the OS of the client 20 can appropriately be selected from various types of OS. When a plurality of clients 20 exist, different OSs can be used in the respective clients 20. Furthermore, the WEB browser 21 can appropriately be selected from various types of WEB browser software in which Java virtual machine (Java VM) can operate, such as Internet Explorer of Microsoft Co. and Netscape Communicator (Navigator) of AOL Time Warner Co. When a plurality of clients 20 exist, different types of WEB browser software can be selected in the respective clients 20.

Furthermore, the WEB data server 30 includes: a data storage section 31 in which numeric data, and the like are stored; an applet storage section 32 in which a Java applet (program operating on the WEB browser 21) to be executed in the WEB browser 21 of the client 20 is stored; a provided data selection section 33 for selecting the Java applet and data to be rendered to the client 20 in response to a request from the client 20; and data server communication section 34 (including program module transmission means (not shown)) for performing communication with the client 20. Here, the provided data selection section 33 is a software block realized by the program-controlled CPU 101 shown in FIG. 2. The program for controlling the CPU 101 to realize these functions is stored and distributed in the storage mediums such as the magnetic disk, optical disc, and semiconductor memory, or distributed and provided via the network, and read in the main memory 103. Moreover, the data server communication section 34 is realized by the network interface 106, and the data storage section 31 and applet storage section 32 are realized by the hard disk 105. It is to be noted that the data or program held in the main memory 103 can be taken into the storage devices such as the hard disk 105 as the occasion demands.

In the WEB data server 30, the client communication section 22 of the client 20 requests the data server communication section 34 to transmit the Java applet which is a program module. Then, the provided data selection section 33 takes necessary Java applet from the applet storage section 32, and the data server communication section 34 transmits the taken Java applet to the client communication section 22. Moreover, when the client communication section 22 of the client 20 requests the data server communication section 34 to transmit the data, the provided data selection section 33 takes the necessary data from the data storage section 31, and the data server communication section 34 transmits the taken data to the client communication section 22.

Furthermore, the WEB application server 40 includes: a printing data preparation section 41 for preparing the data for printing based on printing information transmitted from the client 20; an image data preparation section 42 for preparing image data (GIF file 45 in the present embodiment); a form data storage section 43 in which form data for burying the GIF file 45, and the like prepared by the printing data preparation section 41 is stored; and an application server communication section 44 (including server transmission means, server reception means (both not shown)) which performs communication with the client 20. In the present embodiment, a GIF encoder for generating a graphic interchange format (GIF) file as the image data preparation section 42. It is to be noted that a joint photographic experts group (JPEG) encoder, and the like can also be used as the image data preparation section 42 in addition to the GIF encoder. Moreover, various types of forms of a portable document format (PDF) file are stored in the form data storage section 43. Furthermore, the printing data preparation section 41 prepares the PDF file as the data for printing based on the image data from the image data preparation section 42, form data from the form data storage section 43, and the like, and operates by the Java Servlet. Additionally, a storage section for printing output 41a in which the prepared GIF file 45, and the like are temporarily stored is disposed in the printing data preparation section 41.

Here, the printing data preparation section 41 and image data preparation section 42 are software blocks realized by the program-controlled CPU 101 shown in FIG. 2. The program for controlling the CPU 101 to realize these functions is stored and distributed in the storage mediums such as the magnetic disk, optical disc, and semiconductor memory, or distributed and provided via the network, and read in the main memory 103. Moreover, the application server communication section 44 is realized by the network interface 106, the storage section for printing output 41a is realized by the main memory 103, and the form data storage section 43 is realized by the hard disk 105. It is to be noted that the data or program held in the main memory 103 can be taken into the storage devices such as the hard disk 105 as the occasion demands.

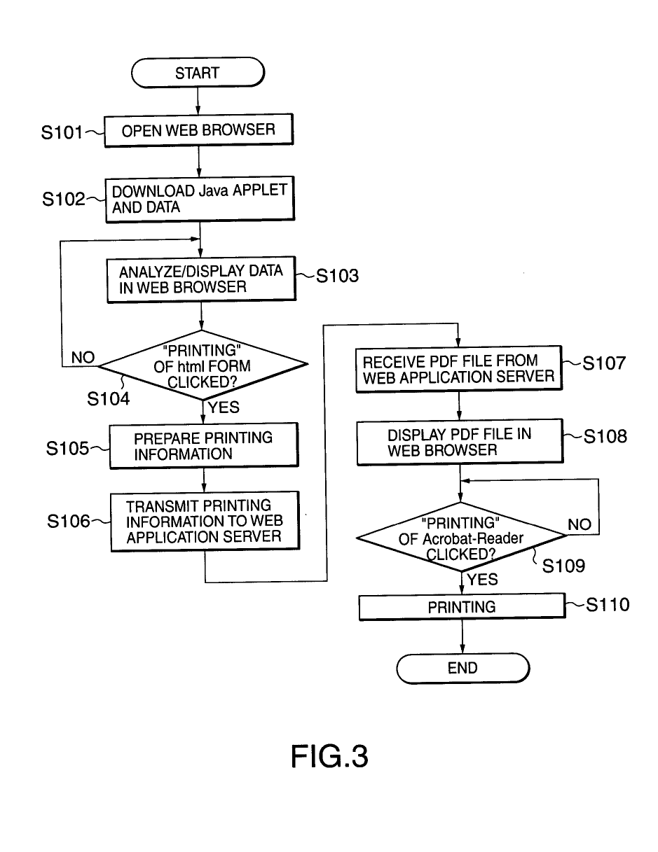

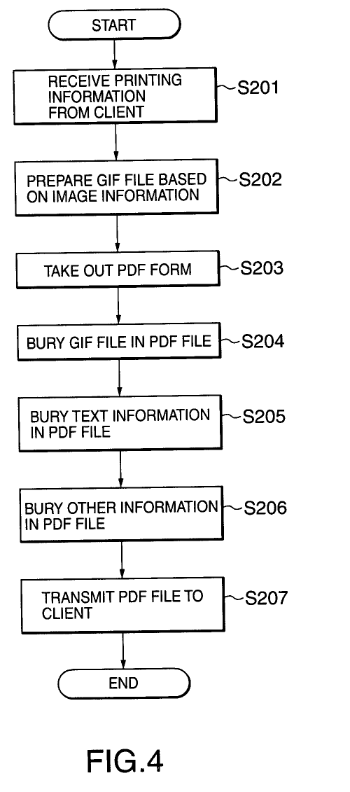

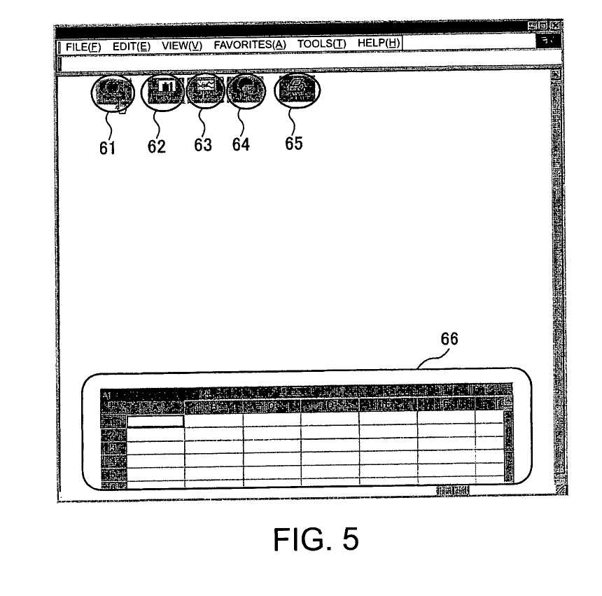

Next, a case in which the data is analyzed will be illustrated, and the operation in the client server system according to the present embodiment, data analysis, and printing of a data analysis result will be described. Here, FIG. 3is a flowchart showing processing in the client 20, and FIG. 4 is a flowchart showing image in the WEB application server 40. Moreover, FIGS. 5 to 11 are diagrams showing the image displayed in the WEB browser 21 of the client 20 in the process of the data analysis and printing of the data analysis result.

First, processing in the client 20 will be described mainly with reference to FIG. 3.

When a user opens the WEB browser 21 of the client 20 (step S101), Java applet and data are downloaded from the WEB data server 30 (step S102).

Subsequently, a screen shown in FIG. 5 is displayed in the WEB browser 21 by the Java applet downloaded in the client 20. In the shown example, in order from the left side of a display screen upper part, a retrieve button 61 for calling the data to be analyzed, a bar chart button 62 for displaying a bar chart, a line chart button 63 for displaying a line chart, a pie chart button 64 for displaying a pie chart, and a print button 65 for printing the image are displayed. A blank datasheet 66 is displayed in a lower part of the display screen. Next, when the user clicks the retrieve button 61 to set desired conditions, data satisfying the conditions is transmitted (downloaded) from the WEB data server 30. Thereafter, the downloaded data is displayed in the datasheet 66.

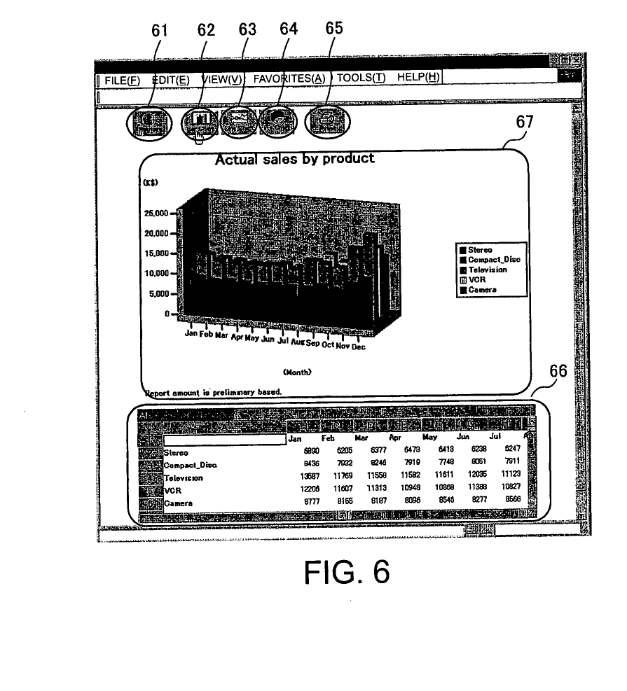

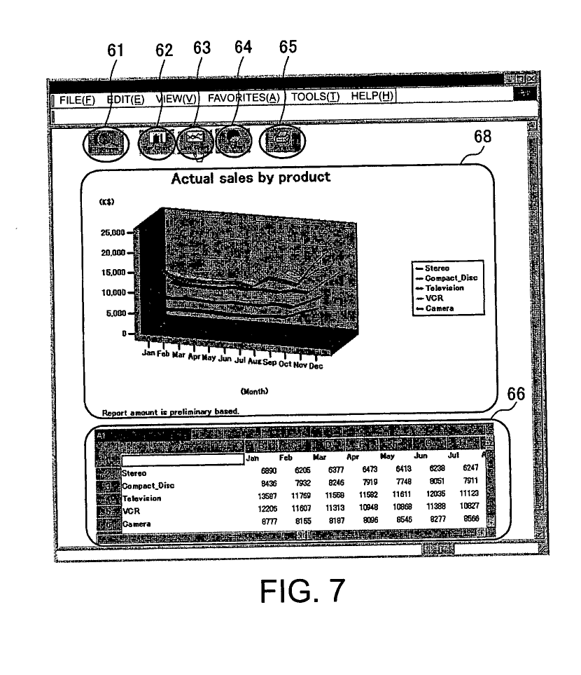

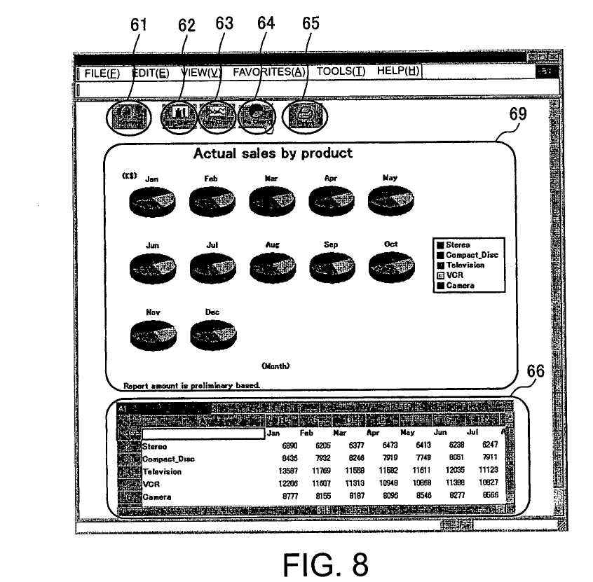

Next, the data is analyzed on the WEB browser 21 by a user's operation, and the analysis result of the data is displayed in the WEB browser 21 (step S103). Concretely, for example, when the user clicks the bar chart button 62 displayed in the WEB browser 21, a bar chart 67 is displayed in the upper part of the datasheet 66 based on the datasheet 66 (see FIG. 6). When the line chart button 63 is clicked, a line chart 68 is displayed (see FIG. 7). When the pie chart button 64 is clicked, a pie chart 69 is displayed (see FIG. 8). These charts are prepared by the downloaded Java applet, and a hyper text markup language (html) is used to display the prepared charts in the WEB browser 21.

It is to be noted that in this example the user is assumed to analyze monthly sales by product such as an electrical product. Moreover, only the amounts of January (Jan) till July (Jul) are displayed in the datasheet 66 displayed in the WEB browser 21, but in actual data from August until December is hidden, and actual sales for January until December are displayed in charts 67 to 69.

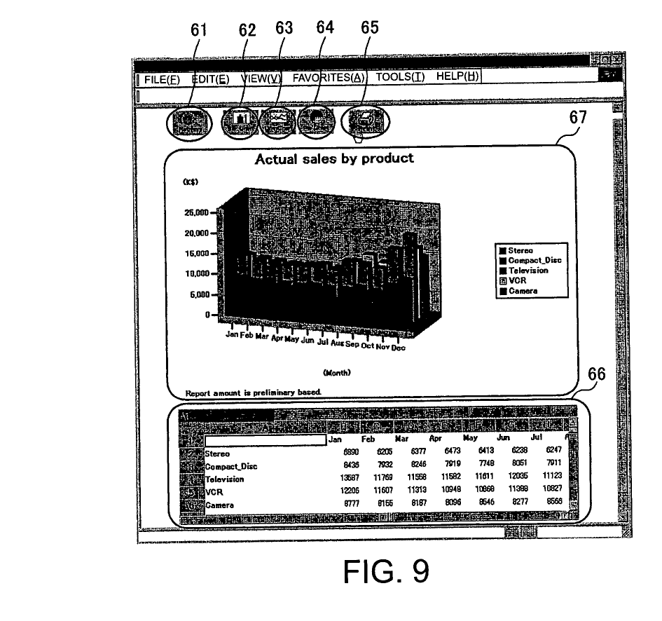

Subsequently, it is judged whether or not the user has clicked the print button 65 displayed in an html form of the WEB browser 21 (step S104). When the print button 65 is clicked, the printing information is prepared based on display content of the WEB browser 21 (step S105), and the prepared printing information is transmitted to the application server communication section 44 of the WEB application server 40 from client transmission means of the client communication section 22 (step S106). Therefore, the WEB browser 21 also functions as means for judging whether or not there has been a printing instruction with respect to the image displayed in the WEB browser 21. Moreover, the printing request and printing information with respect to the WEB application server 40 are prepared by the downloaded Java applet. Therefore, this Java applet functions as means for preparing the printing information. It is to be noted that in this description, as shown in FIG. 9, the print button 65 is assumed to have been clicked in a displayed state of the bar chart 67. Moreover, the prepared printing information includes image information on the bar chart 67, text information on the text source of the datasheet 66, and other additional information (preparation date, and the like). Details of the image information will be described later. On the other hand, when the print button 65 is not clicked, the processing returns to the step S103 to continue the data analysis.

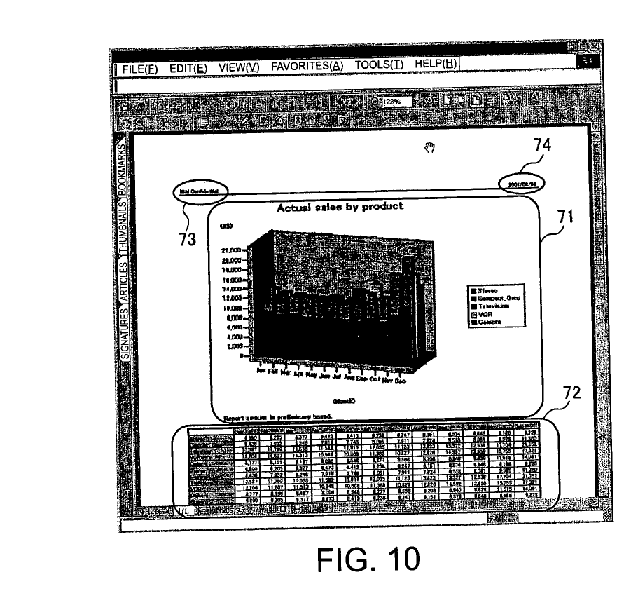

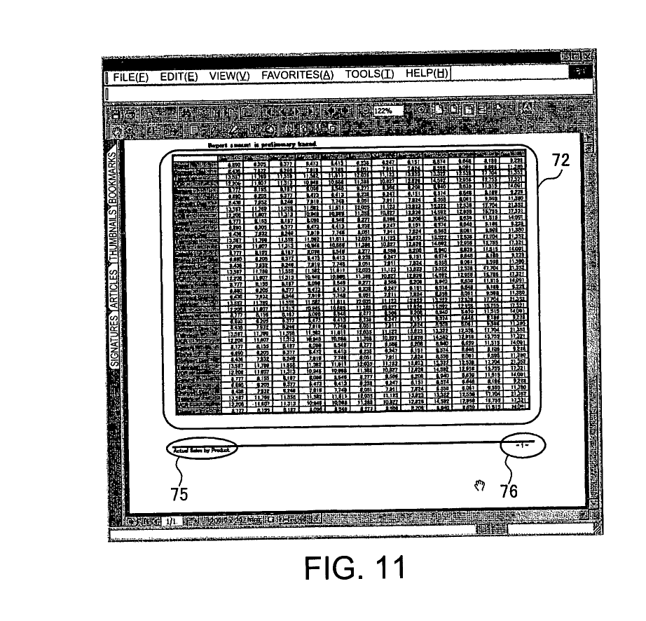

Thereafter, the client 20 receives the PDF file prepared by the WEB application server 40 based on the transmitted printing information via the client reception means of the client communication section 22 (step S107). The received PDF file is displayed in the WEB browser 21 using Acrobat-Reader Plug-in (Acrobat-Reader is a trademark of Adobe Systems Incorporated) (step S108). Here, FIGS. 10 and 11 are diagrams showing that the received PDF file is displayed in the WEB browser 21, FIG. 10 shows an upper part of the PDF file including a bar chart 71 and an upper part of a datasheet 72, and FIG. 11 shows a lower part of the PDF file including a datasheet 72 displayed by scrolling FIG. 10 downwards. As seen from FIGS. 10 and 11, in the datasheet 72 of the PDF file, all data of January until December are displayed, different from the datasheet 66 in the display screen being analyzed (see FIG. 7). Moreover, items which have not existed in the display screen of the WEB browser 21 being analyzed are displayed, such as notes 73, preparation date 74, title 75, and page number 76. It is to be noted that the preparation process of the PDF file will be described later.

Subsequently, it is judged whether or not the user has clicked the print button of Acrobat-Reader (or the print button of the WEB browser 21) (step S108). When the print button is clicked, the PDF file displayed in the WEB browser 21 is printed by the printer 50 (step S109), and a series of processes are ended. Since the PDF file is printed at this time, a satisfactory printing result is obtained regardless of the type of the OS of the client 20 or the WEB browser software of the WEB browser 21. On the other hand, when the print button is not clicked, the processing returns to the step S108 to wait until the print button is clicked. In the present embodiment, the WEB browser 21 and printer 50 function as output means.

The processing in the WEB application server 40 will now be described with reference to FIG. 4. First, the printing information transmitted from the client communication section 22 of the client 20 is received by the application server reception means of the application server communication section 44 of the WEB application server 40 (step S201). Next, the printing data preparation section 41 transfers the image information included in the received printing information, the information on the bar chart 67 shown in FIG. 9 here to the image data preparation section 42. The image data preparation section 42 prepares the GIF file 45 based on the transferred image information (step S202), and returns the file to the printing data preparation section 41. The returned GIF file 45 is temporarily stored in the storage section for printing output 41a. Moreover, the printing data preparation section 41 takes out an appropriate form of the PDF file from the form data storage section 43 (step S203), and the GIF file 45 is embedded in the taken PDF file (step S204). The PDF file in which the GIF file 45 is embedded is temporarily stored in the storage section for printing output 41a. Subsequently, in the PDF file in which the GIF file 45 is embedded, the printing data preparation section 41 further buries the text information included in the received printing information (step S205), and buries other additional information such as the notes, preparation date, title, and page number (step S206). Finally, the application server transmission means of the application server communication section 44 transmits the completed PDF file to the client communication section 22 of the client 20 (step S207), and ends a series of processing.

The printing information to be transferred to the WEB application server 40 from the client 20 will be subsequently described in greater detail.

In the present embodiment, the Java applet operates in the WEB browser 21 of the client 20, and the Java Servlet operates in the printing data preparation section 41 of the WEB application server 40. In many cases, the version of the Java applet is JDK1.1, while the version of the Java Servlet is JDK1.2 or newer which are newer than JDK1.1. This is because much of the WEB browser software for general use by the client 20 at present corresponds only to the version JDK1.1 of Java. On the other hand, since the WEB server 10 is not bound in this manner, a new version is easily used.

A technique referred to as applet-servlet communication can be used to perform the communication between the client 20 and WEB application server 40. Therefore, it is considered that the applet-servlet communication is used to receive/transfer the printing information. However, in Java, it is easy to receive/transfer primitive data such as int or boolean but difficult to receive/transfer image data (image information). Particularly, when the version JDK1.1 is used as the Java applet, and version JDK1.2 is used as the Java Servlet, both application program interfaces (API) are different. Even when the image data prepared on the Java applet side is transmitted as such, the image data cannot be recognized on a Java Servlet side.

Therefore, the image data needs to be converted to a format which can be identified by both the Java applet (JDK1.1) and Java Servlet (JDK1.2 or more). Then, in the present embodiment, the image displayed in the WEB browser 21 of the client 20 with the Java applet (e.g., the bar chart 67) is converted to the primitive type data by a pixel grabber class which can be identified by both, and is thereafter transmitted as the image information to the WEB application server 40. In the pixel grabber class, the information (colors of pixels) managed as the image can be converted to the data of the primitive type in arrangement (two-dimensional) of Integer type (32 bits), which can be subjected to client-server communication. Therefore, the image (e.g., the bar chart 67) is converted into the arrangement of Integer type in the client 20, and transmitted to the WEB application server 40. The data (arrangement of Integer type) received by the WEB application server 40 is converted to the image, and the image can be received/transferred.

It is to be noted that in the present embodiment the WEB application server 40 includes the image data preparation section 42 (GIF encoder in the present embodiment). It is also considered that the GIF encoder is embedded in the Java applet, the client 20 uses the Java applet to first prepare the GIF file, and the printing information including the GIF file is transmitted to the WEB application server 40. However, when the GIF encoder is bundled in the Java applet, the size of the Java applet increases. Additionally, the same number of licenses of the GIF encoder as that of clients 20 have to be unfavorably purchased.

Moreover, the text information is of a type common between the versions JDK1.1 and JDK1.2. Therefore, the information does not have to be converted like the image data, and can be received/transferred as such. Additionally, for the text information, not only the data displayed in the WEB browser 21 (data of January till June in the present embodiment) but also data which is not displayed (data of July till December in the present embodiment) need to be received/transferred. Therefore, it is necessary to receive/transfer the source of the text data.

Furthermore, for other additional information, it is possible to appropriately set the information which is displayed or is not displayed in the WEB browser 21. It is also possible to set contents to be described such as the title beforehand, or to set the contents by the user in clicking the print button 65.

In the present embodiment, the method comprises: using the Java applet to transmit the information of the chart or datasheet displayed in the WEB browser 21 of the client 20 to the WEB application server 40;

preparing/changing the information in a PDF format irrelevant to the Java applet; and again transmitting the information to the client 20. Therefore, when the PDF file received by the client 20 is printed from the printer 50, the satisfactory printing result can be obtained regardless of the type of the client's OS or WEB browser software.

It is to be noted that in the present embodiment the PDF file is prepared in the WEB application server 40, but the present invention is not limited to this. A file of a printable format such as a printable html file may also be prepared by the client 20. Moreover, instead of the files such as the PDF file, the WEB application server 40 may prepare the data for printing, for example, of a binary stream format. In this case, the image for printing is prepared based on the data for printing received by the client. However, since this data for printing is also unrelated to the Java applet, and when the data for printing received by the client 20 is printed from the printer 50, the satisfactory printing result can be obtained regardless of the type of the client's OS or WEB browser software.

Moreover, in the present embodiment, the GIF file 45 has been used as the image file to be embedded in the PDF file, but the present invention is not limited to this, and the file may appropriately be selected from various types of image formats such as JPEG and portable network graphics (PNG).

Furthermore, in the present embodiment, the example in which the client server system is used to analyze the data and the analysis result is printed has been described, but the present invention is not limited to this. The present invention can be applied to a case in which the program operating on the WEB browser 21 of the client 20 is used to print the image drawn in the WEB browser 21.

Additionally, in the present embodiment, the WEB data server 30 and WEB application server 40 are used by function. However, the present invention is not limited to this. Of course, one server may have the functions of the WEB data server 30 and WEB application server 40.

As described above, according to the present invention, a program operating on the WEB browser can be used to print the image displayed in the WEB browser as desired.

What is claimed:

1. A client server system comprising:
a client comprising a WEB browser for browsing a WEB page;
a server connected to the client via a network, wherein the client comprises client means for transmitting printing information corresponding to an image displayed in the WEB browser to the server by using a program operating on the WEB browser;
the server further comprising printing data means for preparing the data for printing based on the received printing information; and
server means for transmitting the data for printing prepared by the means for preparatiing the data for printing to the client.

2. The client server system according to claim 1, wherein a plurality of clients having different operating systems or WEB browser software are connected to the server via the network.

3. The client server system according to claim 1, wherein the printing information includes information on the image displayed in the WEB browser and/or information on a source of text displayed in the WEB browser.

4. The client server system according to claim 1, wherein the printing information includes additional information displayed or non-displayed in the WEB browser.

5. A client comprising:
means for judging whether or not there has been a printing instruction with respect to an image displayed in a WEB browser using a program operating on the WEB browser;
means for preparing printing information based on the printing instruction, when the means for judging determines that there has been a printing instruction;
means for transmitting printing information prepared by the means for preparing printing information to a server via a network;
client means for receiving data for printing prepared by the server based on the printing information transmitted by the client transmission means from the server via the network; and
output means for outputting the data for printing received by the client reception means.

6. The client according to claim 5, wherein the program operating on the WEB browser is a Java applet downloaded via the network.

7. A server comprising:
server means for receiving printing information on an image prepared by a program operating on a WEB browser of a client;
client means for preparing data for printing based on printing information received by the server means for receiving; and
server means for transmitting the data for printing prepared by the client means for preparing the data.

8. The server according to claim 7, wherein the data for printing is a portable document format (PDF) file.

9. The server according to claim 7, further comprising:
means for storing form data prepared by the means for preparing the data for printing; and
means for preparing image data of the data for printing.

10. A computer apparatus comprising:
means for transmitting a program module for preparing printing information based on an image displayed in a WEB browser of a client to the client; and
means for preparing data for printing based on printing information prepared using the program module and transmitted from the client.

11. A method for printing an image, comprising:
judging whether or not there has been a printing instruction with respect to an image displayed on the WEB browser using a program operating on a WEB browser;
preparing printing information based on the printing instruction;
transmitting the prepared printing information to a server via a network;
receiving data for printing prepared based on the printing information by the server via the network; and
outputting the received data for printing.

12. A preparing method for printing an image, comprising:
receiving printing information on the image prepared by a program operating on a WEB browser of a client;
preparing data for printing based on the received printing information; and
transmitting the prepared data for printing to the client.

13. A method for preparing to print an image, comprising:
transmitting a program module for preparing printing information based on the image displayed in a WEB browser of a client to the client; and
preparing data for printing based on the printing information prepared using the program module and transmitted from the client.
